(19) United States
(12) Patent Application Publication
(10) Pub. No.: US 2011/0036493 A1
(43) Pub. Date: Feb. 17, 2011

(54) SURFACE TREATMENT METHOD FOR COPPER AND SURFACE TREATMENT METHOD FOR PRINTED WIRING BOARD

(76) Inventors: Toshinori Kawamura, Ibaraki (JP); Haruo Akahoshi, Ibaraki (JP); Kunio Arai, Kanagawa (JP)

Correspondence Address: JORDAN AND HAMBURG LLP, 122 EAST 42ND STREET, SUITE 4000, NEW YORK, NY, 10168, US

(21) Appl. No.: 12/921,656

(22) PCT Filed: Feb. 25, 2009
(86) PCT No.: PCT/JP2009/053411

§ 371 Date: Nov. 3, 2010

(30) Foreign Application Priority Data
Mar. 10, 2008 (JP) 2008-060140

(51) Int. Cl. B29C 65/16; C25D 11/34

(52) U.S. Cl. 156/272.8; 205/333

(57) ABSTRACT

The present invention provides a surface treatment method for a printed wiring board to form cupric oxide on a surface of an outer layer of copper foil of a laminated board formed by laminating copper foils to base resin layers the cupric oxide being formed to have thickness 0.6 μm to 3.0 μm by performing electrolytic anodizing in an alkaline aqueous solution containing copper oxide ions at a concentration of more than 0.001 mol/l but not more than the saturation point, under the conditions that the electrolytic solution contains sodium hydroxide or potassium hydroxide of 2 mol/l to 6 mol/l and liquid temperature is 50° C. to 90° C.

### BACKGROUND OF THE INVENTION

The present invention relates to a surface treatment method for forming a copper oxide film mainly composed of cupric oxide on a surface of copper, and a surface treatment method for a printed wiring board formed by laminating copper foils on a base resin.

Recently, in accordance with reduction in size and weight of electronic devices, higher wiring density has been required for a printed wiring board. Accordingly, technology for a so-called multilayer printed wiring board to alternately laminate insulation layers and wiring layers (conductor layers) has been advancing. As manufacturing technology of a multilayer printed wiring board, inter-layer connection to electrically connect wiring layers in the vertical direction is becoming increasingly important.

As an inter-layer connection method, there has been a method to use through holes or blind via holes (closed-end holes), a method to use interstitial via holes, and the like.

Although a drill machining method, a laser processing method and the like are considered as a hole boring method, the laser processing method has been proliferate in view of downsizing of diameters of processed holes, processing speedup and the like. In particular, the CO₂ laser having high laser energy has been most widely used.

Since laser light is reflected at a surface of copper foil in the wavelength range of the CO₂ laser, the processing is troublesome. Accordingly, a conformal mask method or a large window method has been used to perform laser processing after copper foil is previously eliminated by etching around the positions where holes are to be formed.

With the conformal mask method or the large window method, however, patterning process of copper foil is required and correction of positional drift of holes is difficult. Accordingly, technology for copper foil surface treatment has been examined to directly process copper foil with the laser.

As a method to enhance absorptance of laser light at a surface of copper foil, a surface blackening treatment method to chemically form a copper oxide film on a surface of copper foil has been disclosed (for, example, Japanese Patent Application Laid-Open No. 2006-339259: hereinafter referred as Patent Document 1).

### SUMMARY OF THE INVENTION

However, since the treatment takes time with the method of Patent Document 1, it has been difficult to improve productivity. Further, since sodium chlorite used for the treatment is expensive, the running cost has been high. Furthermore, since the oxidizing reactivity of sodium chlorite is very strong, handling and maintenance management have been troublesome.

An object of the present invention is to provide a surface treatment method (surface blackening treatment method) for a printed wiring board excellent in productivity, capable of reducing running cost, and easy in handling and maintenance management.

A first aspect of the invention provides a surface treatment method for copper to form, on a surface thereof, a copper oxide film mainly composed of cupric oxide, wherein electrolytic anodizing is performed in an alkaline aqueous solution containing copper oxide ions at a concentration of more than 0.001 mol/l but not more than the saturation point.

In this case, the alkaline aqueous solution preferably contains sodium hydroxide or potassium hydroxide of 2 mol/l to 6 mol/l.

In addition, liquid temperature of the alkaline aqueous solution is preferably 50° C. to 90° C.

A second aspect of the invention provides a surface treatment method for a printed wiring board for processing, with a laser, a hole to connect an outer layer of copper foil (5) and an inner layer of copper foil (3) of the printed wiring board (10) having resin layers (1, 4) and copper foils (3, 5) alternately laminated, wherein a copper oxide film (6) mainly composed of cupric oxide is formed on a surface of the outer layer of copper foil by performing electrolytic anodizing in an alkaline aqueous solution (30) containing copper oxide ions at a concentration of more than 0.001 mol/l but not more than the saturation point.

In this case, thickness of the cupric oxide film is preferably 0.6 μm to 3.0 μm.

According to the present invention, running cost can be reduced while improving operational efficiency to form a copper oxide film on a surface of copper foil, for example, for a printed wiring board.

Here, numerals in parentheses are added for convenience to easily refer to the drawings and are not to limit the present invention.

### BRIEF DESCRIPTION OF THE DRAWINGS

FIG. 1 is a view illustrating a surface treatment process for a printed wiring board according to an embodiment of the present invention.

FIG. 2 is a table indicating treatment conditions of the surface treatment and the results thereof according to the embodiment of the present invention.

FIG. 3 is a table indicating treatment conditions of the surface treatment and the results thereof according to the embodiment of the present invention.

FIG. 4 is a table indicating treatment conditions and the results thereof in the related art.

### DETAILED DESCRIPTION OF THE INVENTION

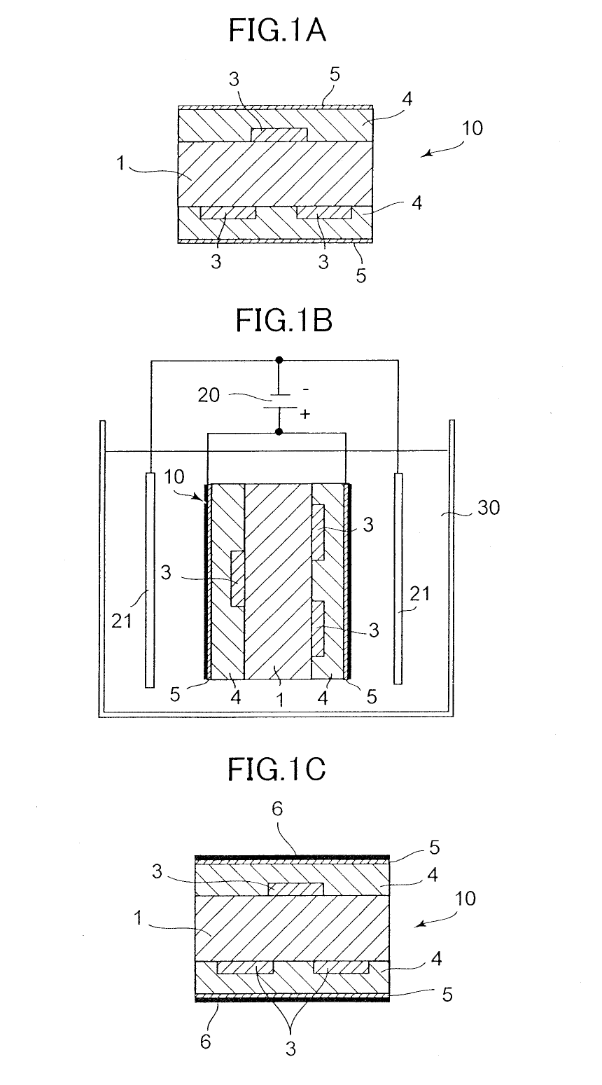

In the following, a surface treatment method for a printed wiring board will be described with reference to FIGS. 1 to 3.

FIGS. 1A to 1C are views illustrating a surface treatment process of the present embodiment. FIG. 1A illustrates a section before the surface treatment, FIG. 1B illustrates an electrolyte cell for the surface treatment, and FIG. 1C illustrates a section after the surface treatment.

As illustrated in FIG. 1A, a printed wiring board 10 before the surface treatment is formed in such a manner that copper foils with resin (for example, copper-clad laminates MCL-E679 manufactured by Hitachi Chemical Co., Ltd.), each integrally having a copper foil 5 and a resin insulation layer 4 not impregnated glass fabrics, are laminated by pressing respectively to the front face side and the rear face side of an inner layer substrate 1 which is a resin having inner circuits configured with copper foils 3. The printed wiring board 10 includes copper foils of four layers constituted with the two outer layer copper foils 5 and the two inner layer circuits 3. Here, the thickness of the copper foil 5 is 9 μm.

First, previous to the surface treatment, a pretreatment of the printed wiring board 10 (in this case, called the printed wiring board 10 although a pattern is not formed on the copper foil 5) is performed in the following order:

(1) First, a surface of the copper foil 5 is degreased by being immersed in a sodium hydroxide solution having a concentration of 5% and a liquid temperature of 50° C. for 3 minutes, and thereafter, washed with water.

(2) Next, etching is performed on the surface of the copper foil 5 by immersing it in an ammonium persulfate solution having a concentration of 20% and a liquid temperature of 30° C. for 1 minute, and thereafter, the surface is washed with water.

(3) Then, etching is further performed on the surface of the copper foil 5 by immersing it in a dilute sulfuric acid solution having a concentration of 5% and a liquid temperature of 25° C. for 1 minute, and thereafter, the surface is washed with water.

Here, the processes of (2) and (3) are for cleaning the surface of the copper foil 5 (eliminating an oxide film from the surface of the copper foil 5) and no copper oxide film is formed on the surface of the copper foil 5.

Next, electrolytic anodizing (surface blackening) is performed on the printed wiring board 10 on which the pretreatment is previously completed. That is, as illustrated in FIG. 1B, the pretreated printed wiring board 10 is placed into an electrolytic solution 30 which is an alkaline aqueous solution and the current density is kept constant by a direct-current power supply 20 with an electrode 21 as a cathode and the copper foil 5 as an anode. Here, although FIG. 1B illustrates an electrolytic treatment bath of a vertical type, a horizontal type may be employed as well. After a copper oxide 6 is formed on the surface of the copper foil 5 as illustrated in FIG. 1C, rinsing is performed with water, followed by drying.

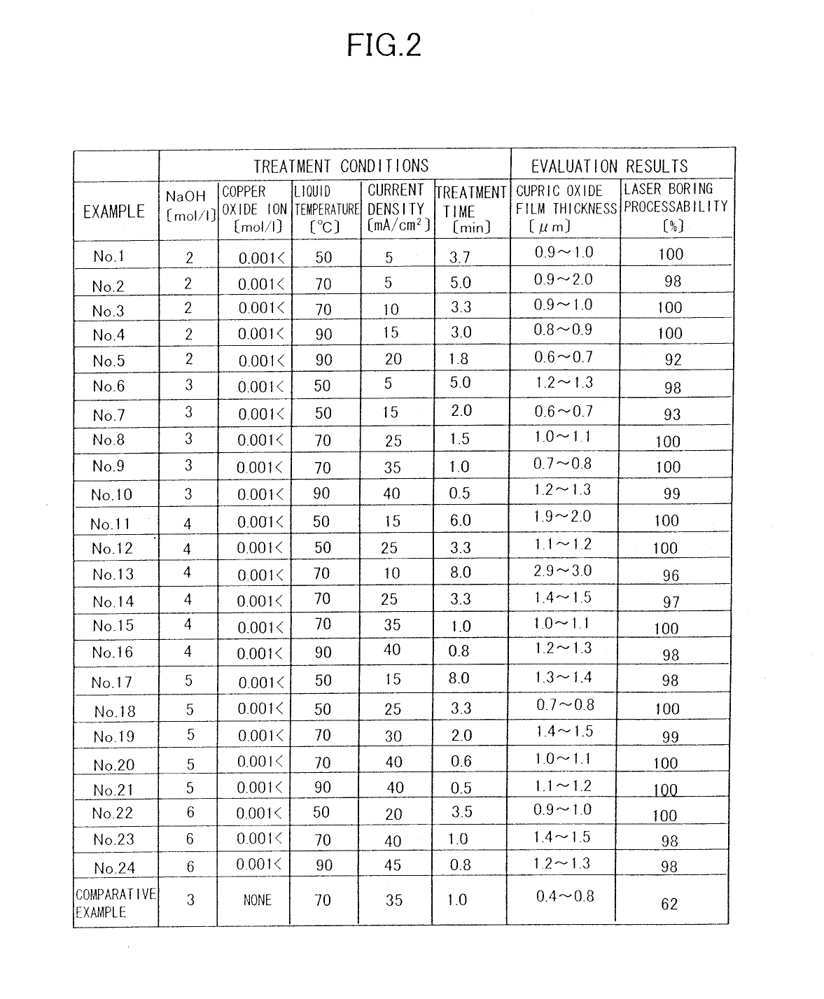

Next, specific conditions and evaluation results of the surface treatment will be described. FIG. 2 is a table indicating the specific conditions and the results of the surface treatment in the case where a sodium hydroxide solution is utilized as the electrolytic solution.

The treatment conditions of the surface treatment (electrolytic anodizing) are indicated as the following (a) to (e).

(a) Electrolytic solution: a sodium hydroxide solution having a concentration of 2 to 6 mol/l

(b) Additive for electrolytic solution: copper oxide ions at a concentration of more than 0.001 mol/l

(c) Liquid temperature of electrolytic solution: 50 to 90° C.

(d) Current density: 5 to 45 mA/cm²

(e) Treatment time: 0.5 to 8 minutes

Although stainless steel was used as the electrode 21, titanium, platinum or copper may be used instead. Here, the copper oxide ion as the additive for the electrolytic solution in (b) refers to any copper oxide ion such as (HCuO₂)⁻, (CuO₂)²⁻ or (CuO₂)⁻ present in alkali. In the present embodiment, copper hydroxide was used for imparting copper oxide ions. However, it is also possible to use copper chloride, copper pyrophosphate, copper sulfate, copper oxide or copper.

Then, the results of the surface treatment were evaluated based on the film thickness of cupric oxide and boring processability by CO₂ laser. Details of the evaluation are described in the following (f) and (g).

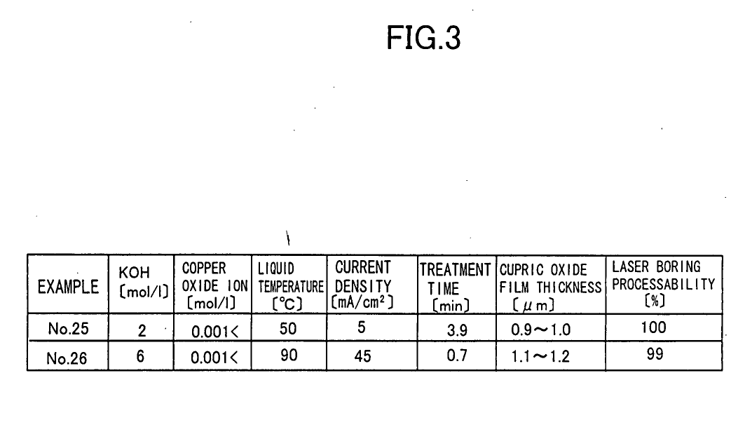

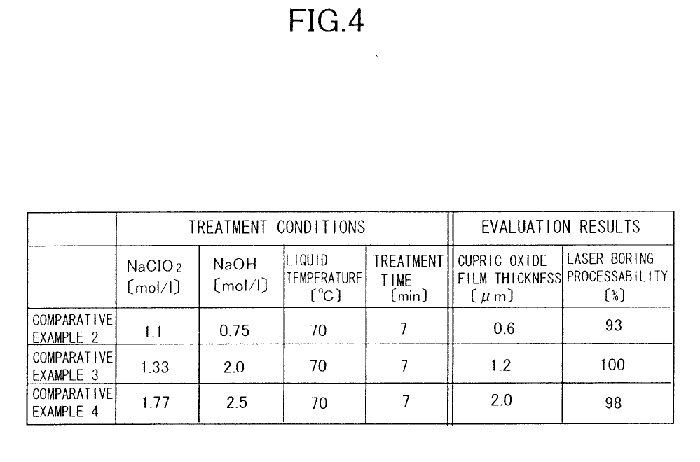

The copper oxide generated in the electrolytic anodizing of the present embodiment is formed of cuprous oxide and cupric oxide. As the production rate, cupric oxide occupies about 80 to 90% while cuprous oxide occupies about 10 to 20%. Since the copper oxide 6 is thus almost entirely formed of cupric oxide, it is described as cupric oxide in FIG. 2 and later-mentioned FIGS. 3 and 4.

(f) Film thickness of cupric oxide: Measurement was performed at three points within the board by utilizing an electrochemical reductive potential method. As the measuring conditions of the electrochemical reductive potential method, the electrode area was 4.5×10⁻² cm², the electrolytic solution was a NaOH solution of 0.1 mol/l, the reference electrode was an electrode of saturated KCL silver/silver-chloride, and the current value was 1 mA.

(g) Evaluation of boring processability: After boring 400 holes by the CO₂ laser, evaluation was performed by the ratio of the number of bored holes having an aimed hole diameter. As the hole boring condition, one-shot processing was performed with a laser energy of 20 mJ and the aimed hole diameter of 80 μm. Here, if the result is that the bored hole diameter is 90% or higher of the aimed hole diameter, it is practically acceptable. Therefore, the case where the bored hole diameter is 90% or higher of the aimed hole diameter was evaluated to be satisfactory.

In addition, in order to confirm the effects of copper oxide ions as the additive for the electrolytic solution, electrolytic anodizing was performed with another electrolytic solution to which copper oxide ions were not added, as Comparative Example 1.

FIG. 3 indicates a case where a potassium hydroxide solution was used as the electrolytic solution. The specific conditions of the surface treatment are the same as those of the case where a sodium hydroxide solution was used as the electrolytic solution.

Further, in order to compare the present embodiment to the related art, Comparative Examples 2 to 4 indicate the data obtained by performing chemical surface blackening treatment based on Patent Document 1.

FIG. 4 is a table indicating the results of the related art. Pretreatment and the evaluation conditions are the same as those of the above cases. The treatment conditions in the related art are indicated as the following (h) to (j).

(h) Treating solution: sodium chlorite at a concentration of 1.1 to 1.8 mol/l and sodium hydroxide at a concentration of 0.75 to 2.5 mol/l

(i) Liquid temperature of treating solution: 70° C.

(j) Treatment time: 7 minutes

Here, the pretreating and the evaluation conditions are the same as those in the cases of FIGS. 2 and 3.

The results of the treatment of the above electrolytic method are summarized as follows.

(A) Regarding Film Thickness of Copper Oxide

Laser boring processability to copper foil is dependent on film thickness of copper oxide and is satisfactory as long as the thickness of cupric oxide is 0.6 μm or more. As clearly seen from FIGS. 2 and 3, in the present embodiment, under the conditions that the electrolytic solution includes a sodium hydroxide solution or a potassium hydroxide solution having a concentration of 2 to 6 mol/l containing copper oxide ions at a concentration of more than 0.001 mol/l and the liquid temperature is 50° C. to 90° C., the film thickness of cupric oxide can be 0.6 μm or more (0.6 μm to 3.0 μm) and the variation of the film thickness within the board can be suppressed to be 0.1 μm or less.

Meanwhile, in the case where copper oxide ions are not added, the film thickness of cupric oxide is 0.4 μm at some part within the board and the film thickness distribution is uneven as the film thickness variation is as large as 0.4 μm. Consequently, as described later, the laser boring processability is decreased. That is, by adding copper oxide ions, cupric oxide can be generated with an even film thickness.

(B) Regarding Processability

Comparing Examples 1 to 26 of the present embodiment to Comparative Examples 2 to 4, satisfactory result was obtained in all of Examples 1 to 26 as the processability was 90% or higher similar to Comparative Examples 2 to 4. Note that, in Comparative Example 1, since copper oxide ions were not added, the film thickness distribution of cupric oxide was uneven and the hole diameter became small at a part where the film thickness of cupric oxide was as thin as 0.4 μm. As a result, the processability was decreased to 62%.

(C) Regarding Treatment Time

In the present embodiment, the treatment time can be shortened by increasing current density. That is, in Examples 9, 10, 15, 16, 20, 21, 23, 24 and 26, the treatment time could be shortened to 1 minute or less. The treatment time resulted in seven-fold or more speedup compared to the related art (7 minutes in Comparative Examples 2 to 4).

Here, even with the treatment method of the present invention, in the case where the concentration of the sodium hydroxide solution or the potassium hydroxide solution and the liquid temperature are low, the film thickness of cupric oxide cannot be 0.6 μm or more.

(D) Running Cost Comparison Between the Surface Treatment of the Present Invention and Chemical Surface Blackening Treatment in the Related Art

(D1) By using a sodium hydroxide solution or a potassium hydroxide solution as the electrolytic solution, cost is reduced and handling becomes easy compared to strongly oxidizing chlorite for chemical surface blackening treatment solution in the related art.

(D2) Copper oxide ions are generated with Cu ions eluted from copper foil of a printed wiring board during electrolytic treatment. Further, since copper oxide ions of more than the saturation amount are precipitated, the amount thereof in the electrolytic solution is constant. Accordingly, it is not necessary to supplement the copper oxide ions in accordance with operation, so that management of concentration of copper oxide ions is easy.

It was confirmed that the result similar to FIGS. 2 and 3 was obtained provided that the concentration of copper oxide ions is more than 0.001 mol/l but not more than the saturation point.

Here, in the above evaluation of processability, CO₂ laser having a wavelength of 9.3 to 10.6 μm was used. However, the present invention is advantageous for a laser having a wavelength in the range of ultraviolet or infrared.

In the case where the outer layer of copper foil 5 is thin (for example, 9 μm), it is practical to set the upper limit of the film thickness of cupric oxide to 3.0 μm or less (i.e., 0.6 to 3.0 μm).

The present invention is also applicable to a publicly known printed wiring board of a rigid or flexible type having copper foil at both faces or one face of resin or resin impregnated glass fabrics.

In the above, the surface treatment of a printed wiring board has been described. However, not limited to a printed wiring board, the present invention can be applied to other applications, such as surface treatment of a current collecting electrode of a battery requiring large surface area by utilizing crystalline microstructure of cupric oxide and surface treatment of a thermal buildup apparatus of solar energy and the like by utilizing high optical absorptance thereof.

The surface treatment method for copper and the surface treatment method for a printed wiring board according to the present invention are available for processing of a copper material used for parts of electronic devices such as cellular phones, computers, digital cameras and televisions, and mechanical devices such as signboards, automobiles and robots. In particular, the present invention is favorable to be adopted for surface treatment of copper foil of wiring layers utilized for treatment to enhance laser light absorptance of copper, for example, for laser processing of boring holes for inter-layer connection at a printed board for the above-mentioned electronic devices. In addition, the present invention is advantageous for improving productivity and facilitating maintenance management.

1. A surface treatment method for copper to form, on a surface thereof, a copper oxide film mainly composed of cupric oxide,
wherein electrolytic anodizing is performed in an alkaline aqueous solution containing copper oxide ions at a concentration of more than 0.001 mol/l but not more than the saturation point.

2. The surface treatment method for copper according to claim 1,
wherein the alkaline aqueous solution contains sodium hydroxide or potassium hydroxide of 2 mol/l to 6 mol/l.

3. The surface treatment method for copper according to claim 1,
wherein liquid temperature of the alkaline aqueous solution is 50° C. to 90° C.

4. A surface treatment method for a printed wiring board for processing, with a laser, a hole to connect an outer layer of copper foil and an inner layer of copper foil of the printed wiring board having resin layers and copper foils alternately laminated,
wherein a copper oxide film mainly composed of cupric oxide is formed on a surface of the outer layer of copper foil by performing electrolytic anodizing in an alkaline aqueous solution containing copper oxide ions at a concentration of more than 0.001 mol/l but not more than the saturation point.

5. The surface treatment method for a printed wiring board according to claim 4,
wherein thickness of the cupric oxide is 0.6 μm to 3.0 μm.

6. The surface treatment method for copper according to claim 2,
wherein liquid temperature of the alkaline aqueous solution is 50° C. to 90° C.
